(19) United States
(12) Patent Application Publication
(10) Pub. No.: US 2026/0014567 A1
(43) Pub. Date: Jan. 15, 2026

(54) SPIDER ASSEMBLY FOR USE WITH A GYRATORY CRUSHER

(71) Applicant: Metso USA Inc., Brookfield, WI (US)

(72) Inventors: Timo Bischof, Münster (DE); Julian Weßeling, Münster (DE)

(73) Assignee: Metso USA Inc., Brookfield, WI (US)

(21) Appl. No.: 18/769,848

(22) Filed: Jul. 11, 2024

(51) Int. Cl. B02C 2/06; B02C 2/04

(52) U.S. Cl. CPC B02C 2/06; B02C 2/045

(57) ABSTRACT

A gyratory crusher and spider for use with the gyratory crusher. The spider includes a pair of spider arms extending from a center hub. Each of the spider arms includes a lower end having a pair of support wings extending in opposite directions from the lower end. The upper top shell of the gyratory crusher includes an upper flange having a generally planar top surface. A pair of seating segments are included on the top surface of the upper flange in spaced locations corresponding to the support wings of the spider arms. The seating segments each receive the support wings on the spider arms to provide a mount for the spider on the top shell. The portions of the upper flange not including the seating segments are planar, which reduces the height of the gyratory crusher.

### BACKGROUND

The present disclosure generally relates to a gyratory crusher including a spider assembly for use in breaking rock, stone, or other materials in a crushing cavity. More specifically, the present disclosure is directed to a spider assembly that includes a spider having a pair of spider arms each having a pair of support wings that are attached to one of a pair of seating segments on the outer rim of a top shell.

Rock crushing machines break apart rock, stone or other materials in a crushing cavity formed between a downwardly expanding conical mantle installed on a main shaft that gyrates within an outer upwardly expanding frustoconically shaped assembly of concaves inside a crusher shell assembly. The conical mantle and the main shaft are circularly symmetric about an axis that is inclined with respect to the vertical shell assembly axis. These axes intersect near the top of the rock crusher. The inclined axis is driven circularly about the vertical axis thereby imparting a gyrational motion to the main shaft and mantle. The gyrational motion causes points on the mantle surface to alternately advance toward and retreat away from the stationary concaves. During retreat of the mantle, material to be crushed falls deeper into the cavity where it is crushed when motion reverses and the mantle advances toward the concaves.

A spider is attached to the top of the shell assembly, forming the top of the support structure for the main shaft. The material to be crushed is typically dropped onto abrasion resistant spider arm shields that are positioned over the arms and central hub of the spider, after which the material to be crushed falls into the crushing cavity. The spider includes a central hub and bushing that receive one end of the main shaft. The crushing forces generated in the crushing cavity create very large loads that are imposed in part on the spider. The spider must be constructed to withstand such loads to avoid having to shut down a crushing line, or an entire mine, to replace and/or repair a damaged spider.

Presently, two different types of spiders are commonly used to rotatably support the main shaft at the top of the top shell of the gyratory crusher. The first type of spider is referred to as a ring or split ring spider, such as shown in the applicants granted U.S. Pat. No. 8,070,084. In this type of ring spider, the spider includes a center hub supported by a pair of spider arms. The spider arms extend outward to an outer ring that supports the entire spider assembly on a top shell of the gyratory crusher. In some embodiments, the ring can be split into three parts to aid in installation and transportation of the spider assembly. Although ring spiders are durable and easy to align during installation, ring spiders are heavy and cumbersome during installation. Further, the size of the ring requires a relatively large number of bolts to attach the spider to the top shell of the crusher.

A second type of spider is referred to as a bone spider. A bone spider includes a center hub and a pair of spider arms extending from the center hub. Unlike a ring spider, a bone spider connects each of the spider arms directly to the upper rim of the top shell. The outer rim of the spider is eliminated, which decreases the overall weight of the bone spider compared to a ring spider. In addition, the elimination of the outer support ring reduces the number of bolts needed and reduces the feeding height of the crusher due to the elimination of the height of the ring. However, bone spiders are not as robust and stiff and special devices and grouting is needed to fix the bone spider to the upper rim of the top shell.

The inventors of the present disclosure have recognized the problems associated with both the ring spider and bone spider and have developed the present disclosure to solve and address the problems and issues associated with each type of currently available spider assembly.

### SUMMARY

The present disclosure relates to a gyratory crusher including a spider assembly for use in breaking rock, stone, or other materials in a crushing cavity. The spider assembly includes a spider formed in accordance with the present disclosure that includes a pair of spider arms each having a pair of support wings that are attached to one of a pair of seating segments on the outer rim of a top shell.

According to one exemplary embodiment of the present disclosure, a gyratory crusher is provided that includes a main frame that includes an upper top shell that is centered about a longitudinal axis. The upper top shell includes an inner wall that extends from a top end to a bottom end. The top end of the upper top shell includes an upper rim that has a width between an inner edge and an outer edge. The upper rim is generally planar over the entire width of the upper rim.

The gyratory crusher includes a spider that is supported on the upper rim of the upper top shell to provide rotational support for the upper end of a main shaft located in the gyratory crusher and centered along the longitudinal axis of the main frame. The spider includes a pair of spider arms that extend from a center hub. When the spider is mounted to the upper rim of the upper top shell, the main shaft is supported in the center hub and the pair of spider arms are supported on and connected to the upper rim of the upper top shell.

Each of the spider arms includes a lower end configured to be connected to and supported on the upper rim. The lower end of each spider arm includes a pair of support wings that each extend in opposite directions from the lower end of the spider arm. The support wings and the outer end of the spider arm provide the support and attachment area for attaching the spider arm to the upper rim.

In accordance with an exemplary embodiment of the present disclosure, the gyratory crusher further includes a pair of seating segments that are positioned on the upper rim of the upper top shell. Each of the seating segments are configured to receive one of the lower ends and support wings formed on one of the spider arms. The engagement of the seating segments and the spider arms securely holds the spider in place on the upper rim of the upper top shell.

Each of the seating segments extends from the top surface of the upper rim and the remaining portions of the upper rim are generally planar. In this way, the height of the upper top shell can be reduced since the seating segments do not extend along the entire circumference of the upper rim. In an exemplary embodiment of the present disclosure, each of the seating segments includes an outer ridge and an inner ridge that are spaced from each other by a receiving channel. Both of the inner and outer ridges extend above the top surface of the upper rim such that the receiving channel has a depth defined by the height of the inner and outer ridges above the tope surface of the upper rim.

The lower end of each of the spider arms is configured to include a beam that extends from the lower end of the spider arm. The beam is sized to be received and retained within the receiving channel formed in one of the seating segments. The beam and the receiving channel have the same degree of curvature such that the beam is retained along the entire length of the beam. In an exemplary embodiment of the present disclosure, the beam extends along the entire length of the lower end of the spider arm and along the length of the pair of support wings extending in opposite directions from the lower end.

In accordance with one embodiment of the present disclosure, each of the pair of seating segments is formed separately from the upper top shell and is attached to the upper rim of the upper top shell. The top surface of the upper rim is generally planar and the seating segments are attached to and extend above the top surface to provide a point of attachment for each of the pair of spider arm.

The present disclosure is also directed to the spider assembly that can be separately provided and used with a gyratory crusher that includes an upper top shell having an upper rim. The spider assembly includes a spider that is supported on the upper rim of the upper top shell to provide rotational support for the upper end of a main shaft located in the gyratory crusher and centered along the longitudinal axis of the main frame. The spider includes a pair of spider arms that extend from a center hub. When the spider is mounted to the upper rim of the upper top shell, the main shaft is supported in the center hub and the pair of spider arms are supported on and connected to the upper rim of the upper top shell

Each of the spider arms includes a lower end configured to be connected to and supported on the upper rim. The lower end of each spider arm includes a pair of support wings that each extend in opposite directions from the lower end of the spider arm. The support wings and the outer end of the spider arm provide the support and attachment area for attaching the spider arm to the upper rim.

The lower end of each of the spider arms is configured to include a beam that extends from the lower end of the spider arm. The beam is sized to be received and retained within the receiving channel formed in one of the seating segments. The beam and the receiving channel have the same degree of curvature such that the beam is retained along the entire length of the beam. In an exemplary embodiment of the present disclosure, the beam extends along the entire length of the lower end of the spider arm and along the length of the pair of support wings extending in opposite directions from the lower end.

In accordance with one embodiment of the present disclosure, each of the pair of seating segments is formed separately from the upper top shell and is attached to the upper rim of the upper top shell. The top surface of the upper rim is generally planar and the seating segments are attached to and extend above the top surface to provide a point of attachment for each of the pair of spider arm.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is a perspective view of a gyratory crusher of one exemplary embodiment of the present disclosure;

FIG. 2 is a perspective view of the upper top shell and the installed spider in accordance with the present disclosure;

FIG. 3 is an exploded view showing the removal of the spider from the upper rim of the upper top shell;

FIG. 4 is a top view of the spider installed on the upper top shell;

FIG. 5 is a section view taken along line 5-5 of FIG. 4;

FIG. 6 is a partial section view showing the interaction between one of the spider arms and one of the seating segments on the upper rim of the upper top shell;

FIG. 7 is a top exploded view showing the positioning of the spider relative to the seating segments on the upper rim of the upper top shell;

FIG. 8 is a bottom perspective view of the spider;

FIG. 9 is a top view of the upper rim of the upper top shell showing the seating segments;

FIG. 10 is a partial section view of a first alternate embodiment of the interaction between one of the spider arms and one of the seating segments on the upper rim of the upper top shell; and

FIG. 11 is a partial section view of a second alternate embodiment of the interaction between one of the spider arms and one of the seating segments along the upper rim of the upper top shell.

### DETAILED DESCRIPTION

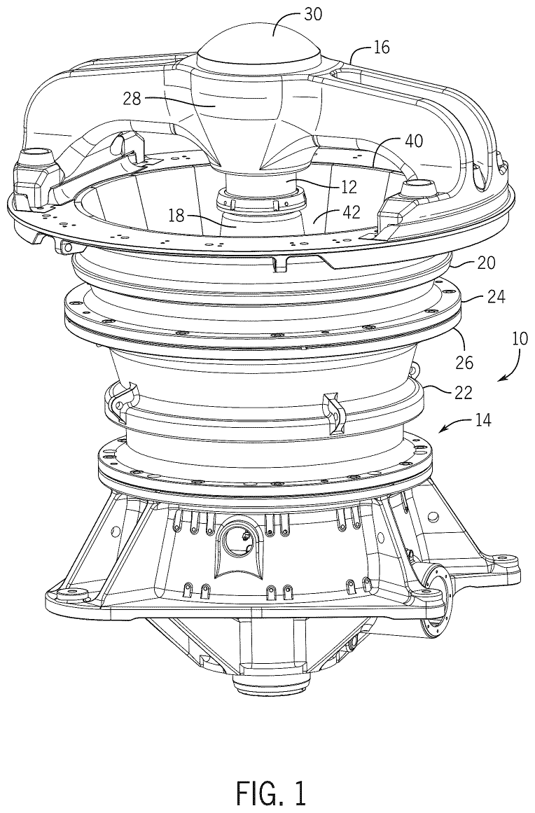

FIG. 1 illustrates a gyratory crusher 10 that incorporates the spider assembly and top shell constructed in accordance with the present disclosure. The view of FIG. 1 is included to provide a general illustration of the basic operating principles of a gyratory cone crusher and is not to be understood to imply any limitation of the present disclosure. The gyratory crusher 10 includes a vertically extending main shaft 12 that extends through a main frame 14. The main shaft 12 has a longitudinal axis that coincides with a central axis of the main frame 14. The main shaft 12 is rotatably supported at the top end of the main shaft 12 by a spider 16 constructed in accordance with the present disclosure. The crusher 10 includes an eccentric assembly that rotatably supports the bottom portion of the main shaft 12. The eccentric assembly is driven by a drive shaft that imparts rotating and oscillating movement to the main shaft 12 through a gear assembly in a known manner.

The main shaft 12 includes a mantle 18 that is mounted to a crusher head. The mantle 18 is designed as a removable wear component that can be removed from the crusher head of the main shaft 12 upon wear. As shown in FIG. 1, the main frame 14 includes an upper top shell 20 and a lower top shell 22 that are mounted on top of each other and joined by an overlapping pair of flanges, designated as the upper flange 24 and the lower flange 26. In this manner, the entire main frame 14 can be formed from a separate upper top shell 20 and a lower top shell 22 that can be assembled on site, which increases the ability to ship the gyratory crusher for assembly on site. Although the main frame 14 includes the upper and lower top shells, it is contemplated that the main frame 14 could be formed including only a single top shell that would then support the spider 16. As is well known, the spider 16 supports the upper end of the rotating main shaft 12 through a series of bushings that are located within a center hub 28 of the spider 16. The center hub 28 is shown in FIG. 1 as including a top cap 30 that is designed as a replaceable wear component.

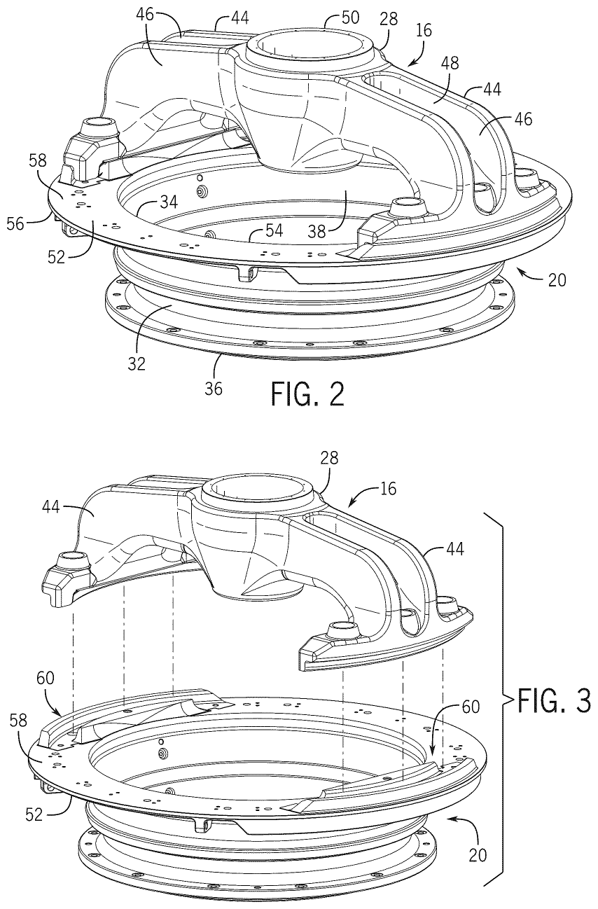

Referring now to FIGS. 2 and 3, the upper top shell 20 and the spider 16 are shown separated from the remaining portions of the main frame of the gyratory crusher 10. The upper top shell 20 includes a frame 32 formed from a durable metal material. The frame 32 extends from a top end 34 to a bottom end 36. The frame 32 includes an inner wall 38 that decreases in diameter from the top end 34 to the bottom end 36 to direct material downward and inward within the frame 32. The frame 32 supports an outer crushing shell 40, also commonly referred to as a bowl, that is mounted to the inner wall 38 of the frame 32 as best shown in FIG. 1. The lower top shell 22 can also support an outer crushing shell. A crushing gap 42 is formed between the outer crushing shells 40 and the mantle supported on the head of the main shaft 12. The size of the crushing gap decreases in a downward vertical direction to reduce the size of material during the crushing operation. When the crusher is operated, material to be crushed is introduced into the crushing gap 42 and is crushed between the mantle and the outer crushing shells 40 as a result of the gyrating movement of the crusher head during which the mantle approaches the outer crushing shell 40 along a rotating generatrix and moves away from the crushing shell along a diametrically opposed generatrix.

Referring back to FIGS. 2 and 3, the spider 16 includes the center hub 28 that is supported by and joined to a pair of spider arms 44. The center hub 28 is centered above the crushing gap and supports the upper end of the main shaft 12 as shown in FIG. 1. As shown in FIGS. 2 and 3, the spider arms 44 extend in opposite directions from the center hub 28 and are designed to space the center hub above the top end 34 of the upper top shell 20. The open spaces on each side of the spider arms 44 allows material to be introduced into the crushing gap from the open top end 34 of the upper top shell 20. In the embodiment shown in FIGS. 2 and 3, each of the spider arms 44 includes a pair of spaced flanges 46 that define an open channel 48 between the flanges 46. The configuration of the spider arms 44 shown is more clearly and thoroughly shown and described in the applicant's granted U.S. Pat. No. 8,070,084.

As shown in FIG. 5, each of the spider arms 44 is designed to receive a spider arm shield 118 to protect the spider arms 44 from material during operation of the gyratory crusher. The center hub 28 includes a center ring 50 that provides a seat for the top cap 30 shown in FIG. 1. The top cap 30 and spider arm shields 55 protect the spider 16 from damage during the introduction of material into the gyratory crusher 10 from above.

As shown in FIGS. 2 and 3, the upper top shell 20 of the present disclosure is designed including an upper rim 52 that is generally planar and extends from an inner edge 54 to an outer edge 56. The width of the upper rim 52 is thus defined by the difference between the diameter of the inner edge 54 compared to the diameter of the outer edge 56. The upper rim 52 includes a top surface 58 that is generally planar and provides a mounting surface for the spider 16 as illustrated in the comparisons of FIGS. 2 and 3. Referring now to FIG. 3, in accordance with the present disclosure, the upper top shell 20 includes a pair of seating segments 60 that are located along spaced areas of the top surface 58 of the upper rim 52. In the embodiment shown, the center of the two seating segments 60 are spaced 180° from the other around the circumference of the upper rim 52. Each of the seating segments 60 is designed to receive one of the two spider arms 44 to support the entire spider 16 on the upper rim 52. Each of the seating segments 60 extends above the top surface 58 while the remaining portions of the top surface 58 are generally smooth and planar. In this manner, seating segments 60 are included on the upper rim 52 at only the locations required to provide radial support for the spider arms 44.

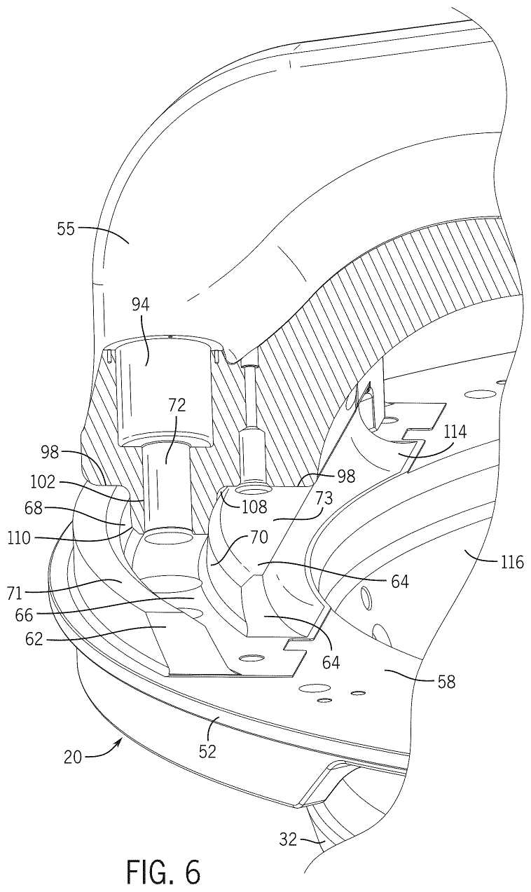

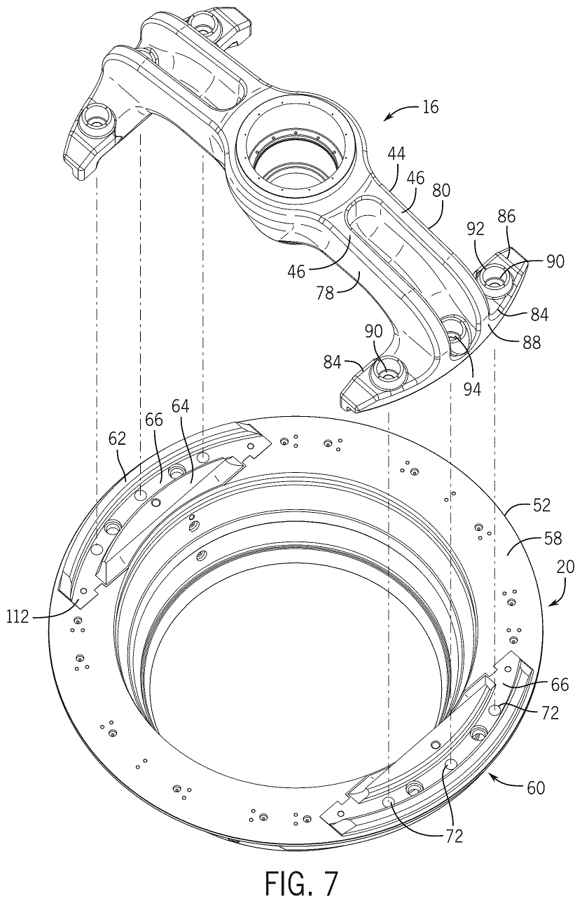

Referring now to FIGS. 7 and 9, each of the seating segments 60 includes an outer ridge 62 and an inner ridge 64 that are spaced from each other to define a receiving channel 66. As can be seen in FIG. 6, both the outer ridge 62 and the inner ridge 64 extend above the top surface 58 by a height that defines the depth of the receiving channel 66. The outer ridge 62 includes a curved inner engagement surface 68 while the inner ridge 64 includes a similar outer engagement surface 70. The distance between the engagement surfaces 68, 70 defines the width of the receiving channel 66 as is shown. The depth of the receiving channel 66 is defined by the distance between the upper surfaces 71 and 73 of the outer and inner ridges 62, 64 and the top surface 58 of the upper rim 52.

Referring back to FIG. 9, the outer ridge 62 has an arc length that is defined by the angle A shown in FIG. 9. The angle A shown in the embodiment is approximately 33°, although this angle defining the arc length can vary depending upon parameters for the gyratory crusher. It is contemplated that the angle A could range between 30 and 100 degrees. The range of the angle A is selected to maximize the weight reduction of the entire spider while providing the required strength and stability for supporting the spider arm 44 along the upper rim 52. The inner ridge 64 has a slightly smaller arc length defined by a slightly smaller angle as compared to angle A. Although the arc length of the inner ridge 64 is shown smaller than the arc length of the outer ridge 62, the arc length of the inner ridge 64 could be extended to be the same as the arc length of the outer ridge 62. During operation of the gyratory crusher, forces on the spider are directed in both a radially inward and a radially outward direction such that the length of the receiving channel 66 must be sufficient to provide support for both inward forces and outward forces acting upon the spider.

As shown in FIG. 7, the seating segment 60 includes a series of receiving openings 72 that are each sized to receive a connector used to secure the spider 16 to the top surface 58 of the upper rim 52. Each of the receiving openings 72 is located within the receiving channel 66 formed between the inner and outer ridges 62, 64. Although three seating segments 60 are shown in the exemplary embodiment, it should be understood that additional openings 72 could be included to join the spider 16 to the upper rim 52.

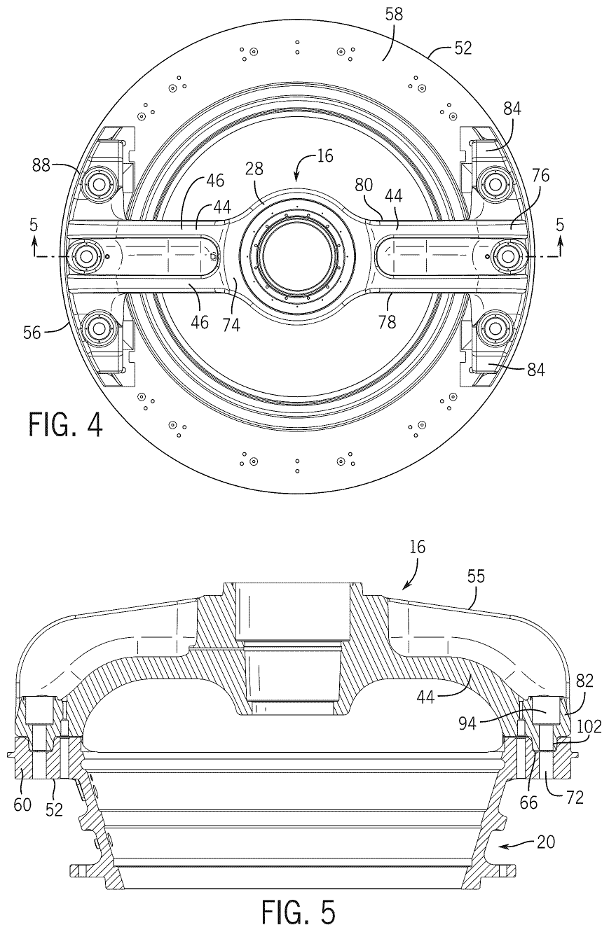

Referring now to FIG. 4, details of the spider 16 will now be described in greater detail. As discussed previously, the spider 16 includes the center hub 28 that is joined to the pair of spider arms 44. Each of the spider arms 44 extends from an inner end 74 joined to the center hub 28 to an outer end 76. As shown in the top view of FIG. 4, each of the spider arms 44 has a width defined between a first side surface 78 and a second side surface 80. The first and second side surfaces 78, 80 are formed on opposite sides of the flanges 46. The spaced first and second side surfaces 78, 80 define the overall width of each of the spider arms 44.

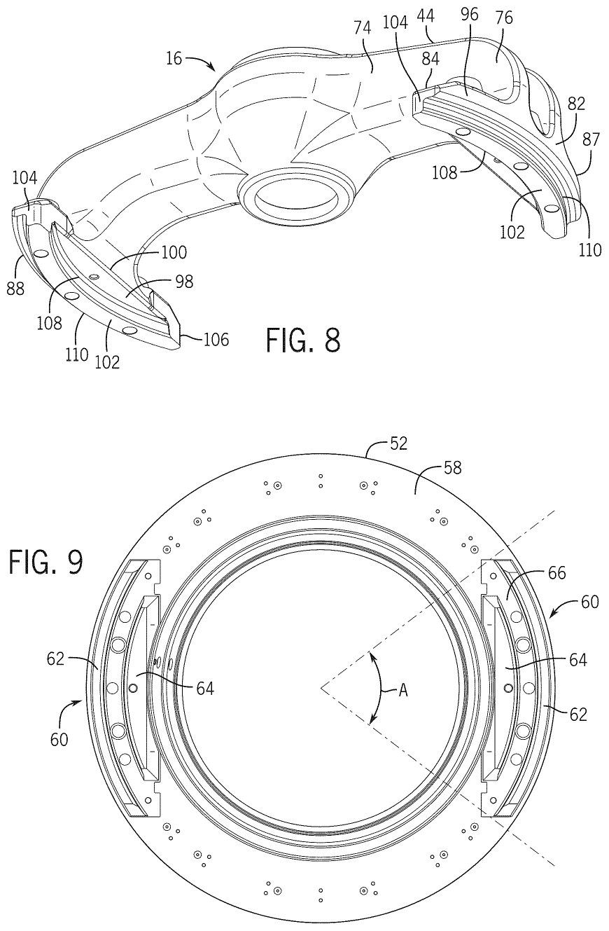

As shown in the bottom view of FIG. 8, each spider arm 44 extends from the inner end 74 to the outer end 76, where the outer end 76 includes a lower end 82. The lower end 82 is integrally connected to a pair of support wings 84 that each extend in opposite directions from the respective spider arm 44. The support wings 84 are designed to provide support for the spider 16 on the top surface 58 of the upper rim 52. The support wings 84 are integrally formed with the respective spider arm 44 such that the entire spider 16 is a monolithic structure that is molded in a single molding step.

As shown in the top view of FIG. 7, each of the support wings 84 includes a top surface 86 and is defined by a radial outer edge 88. The outer edge 88 has a curved shape that generally corresponds to the curved shape of the outer edge 56 of the upper rim 52, as best shown in FIG. 4. The outer edge 88 defined by the pair of support wings 84 and the lower end 82 of the spider arm 44 is spaced slightly inward from the outer edge 56 of the upper rim 52.

As shown in FIG. 7, each of the support wings 84 includes a connector opening 90. In the embodiment shown, each of the connector openings 90 is surrounded by a wall portion 92 that extends above the top surface 86. The connector openings 90 are designed to align with the receiving openings 72 formed in the seating segments 60, as can be understood by the dashed lines in FIG. 7. In addition to the connector openings 90 formed in each of the support wings 84, a connector opening 94 is located between the pair of flanges 46 formed in the spider arm 44. The center connector opening 94 is also aligned with the center receiving opening 72 formed in the seating segment 60. The alignment of the openings formed in the spider arm 44 and the openings formed in the seating segment 60 and upper rim 52 allows three separate connectors to join the spider arms 44 to the upper rim 52 of the upper top shell 20.

Referring now to the bottom view of FIG. 8, the lower end 82 of each of the spider arms 44 includes the pair of support wings 84 extending in opposite directions. Each support wing 84 includes a generally flat wall 96 that defines generally flat lower surfaces 98. The lower surface 98 extends over the entire curved outer edge 88 as well as along the straight inner edge 100. The flat lower surfaces 98 are designed to contact the upper surfaces 71 and 73 of the outer ridge 62 and the inner ridge 64, respectively. Such contact is best shown in the section view of FIG. 6.

Each of the lower ends 82 of the spider arms 44 includes a beam 102 that extends below the lower surface 98. The beam 102 is curved and extends from the first end 104 of the first support wing to a first end 106 of the opposite support wing 84. In this manner, each of the beams 102 extends along the entire length of the combination of the support wings 84 and the lower end 82 of the spider arm. The beam 102 is integrally formed with the remaining portions of the spider 16. Although the beam 102 in the embodiment illustrated extends along the entire length of the support wing 84, it is contemplated that the beam 102 could be truncated and extend along only a portion of the entire length of the support wing 84. In another contemplated configuration, the beam 102 could be segmented with open breaks between the segments of the beam 102.

Each of the beams 102 includes an inner wall 108 and an outer wall 110 that combine to define the width of the curved beam 102. Referring now to the section views of the FIGS. 5 and 6, the width of the curved beam 102 between the inner wall 108 and the outer wall 110 generally corresponds to the width of the receiving channel 66 defined between the engagement surface 68 and the engagement surface 70. When the spider 16 is installed as shown in FIG. 5, the interaction between the beam 102 and the receiving channel 66 limits the radial movement of the spider 16 in both the inward and outward directions. As shown in the section view of FIG. 5, the connector opening 94 formed in the lower end 82 of the spider arm 44 aligns with the receiving opening 72. In this manner, a connector can be used to join the spider arm 44 to the upper rim 52 of the upper top shell 20 in the areas of the seating segments 60.

Referring now to FIGS. 6 and 7, in the embodiment illustrated, each of the seating segments 60 is formed as a separate component that is attached to the top surface 58 of the upper rim 52. Each of the seating segments 60 includes a backing plate 112 that includes the outer ridge 62 and the inner ridge 64. The backing plate 112 is secured to the top surface 58 by a series of connectors such that the seating segments 60 can be attached to the upper rim 52 after creation of the upper top shell 20. As shown in the view of FIG. 6, the inner ridge 64 includes a sloping inner surface 114 that is positioned toward the center opening 116 defined by the frame of the top shell 20.

FIGS. 5 and 6 show a pair of arm shields 55 supported on each of the spider arms 44. Although the spider arms 44 and arm shields 55 are illustrated, it should be understood that various different configurations could be used for each of the individual spider arms 44 while operating within the scope of the present disclosure.

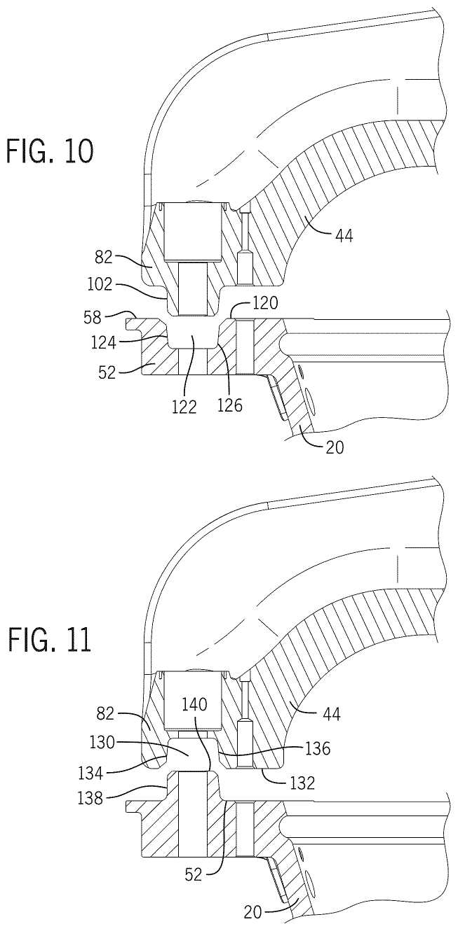

In the embodiment of the disclosure shown in FIGS. 2-9, the seating segments 60 are shown extending above the top surface 58 on the upper rim 52 of the upper top shell 20 and the beam 102 is shown extending below the support wing 84 formed on the lower end 82 of the spider arm 44. The interaction between the beam 102 and the seating segment 60 prevents the radial movement of the lower end 82 of the spider arm 44 during operation of the gyratory crusher. FIGS. 10 and 11 illustrate two alternate configurations that perform the same function in alternate ways, as will be detailed below.

In the first alternate embodiment shown in FIG. 10, the seating segment 120 is formed by a recessed receiving channel 122 that extends below the top surface 58 of the upper rim 52. The recessed receiving channel 122 is defined by an outer ridge 124 and an inner ridge 126 that each extend below the top surface 58. The recessed receiving channel 122 is sized to receive the beam 102 formed on the lower end 82 of the spider arm 44. In the embodiment shown in FIG. 10, the seating segment 120 would be recessed from the top surface 58 and would not require a separate component to be added to the top surface 58 as in the embodiment shown in FIGS. 2-9. The seating segment 120 would extend over the same range of angles as discussed previously and would prevent the radial outward movement of the spider arm 44 during operation.

FIG. 11 illustrates a second alternate embodiment in which the beam on the lower end 82 of the spider arm 44 is removed and replaced with a recessed receiving channel 130 that extends inward from the lower surface 132 on the lowermost portion of the spider arm 44. The recessed receiving channel 130 is defined by an outer ridge 134 and an inner ridge 136. In an exemplary embodiment, the recessed receiving channel 130 extends along the entire length of the support wing formed on the lower end 82 of the spider arm 44. However, the recessed receiving channel 130 could be formed along less than the entire length of the support wing in alternate embodiments. The size of the recessed receiving channel 130 formed on the lower end 82 of the spider arm 44 is configured to closely correspond in size and depth to a beam 138 that is formed on the top surface 58 of the upper rim 52. The beam 138 extends above the top surface 58 and is designed to be received within the recessed receiving channel 130 when the spider is installed on the upper top shell 20. As with the embodiment of FIG. 10, the seating segment 140 extends over the same range of angles as discussed previously and would prevent the radial outward movement of the spider arm 44 during operation.

In the three embodiments illustrated, a seating segment is formed along limited areas on the upper rim 52 of the upper top shell 20 and the remaining areas of the upper rim 52 are generally planar and devoid of any elements. The remaining portions of the upper rim 52 that do not include the seating segments are planar and thus reduce the feeding height of the spider. The embodiments shown include a receiving channel and beam that are located on the lower end of the spider arm and the top surface of the upper rim. The location of the respective receiving channels and beam can be swapped between the spider arm and upper rim while operating within the scope of the present disclosure.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims

We claim:

1. A gyratory crusher, comprising:
a top shell centered about a longitudinal axis, the top shell including an inner wall, an outer wall and an upper rim located at an upper end of the top shell;
a spider supported on the upper rim of the top shell, the spider including a plurality of spider arms each extending radially outward from a center hub, each spider arm including a lower end;
a pair of support wings extending in opposite directions from the lower end of each of the spider arms; and
a pair of seating segments located along the upper rim of the top shell, wherein each of the seating segments is configured to receive one of the lower ends and support wings on one of the spider arms.

2. The gyratory crusher of claim 1 wherein the pair of seating segments extend above a top surface of the upper rim.

3. The gyratory crusher of claim 2 wherein the top surface of the upper rim is planar at locations other than the pair of seating segments.

4. The gyratory crusher of claim 1 wherein each of the pair of seating segments extends circumferentially along the top flange over an angular range of 30-100 degrees.

5. The gyratory crusher of claim 1 wherein each of the seating segments includes an outer ridge and an inner ridge spaced from each other by a receiving channel.

6. The gyratory crusher of claim 5 wherein the lower end of each spider arm includes a beam that extends from the lower end, wherein the beam is sized to be received within the receiving channel.

7. The gyratory crusher of claim 1 wherein the seating segment includes a beam extending above a top surface of the upper rim and the lower end of each spider arm includes a receiving cavity sized to receive the beam.

8. The gyratory crusher of claim 6 wherein the beam extends along a length of the pair of supporting wings past the lower end of each of the spider arms.

9. The gyratory crusher of claim 1 wherein each of the wings includes a connector opening that receives a connector to attach the wing to the upper rim of the top shell.

10. A spider assembly for use with a gyratory crusher including a top shell having an upper rim for supporting the spider assembly, comprising:
a plurality of spider arms each extending radially outward from a center hub, each spider arm including a lower end;
a pair of support wings extending in opposite directions from the lower end of each of the spider arms; and
a pair of seating segments located along the upper rim of the top shell, wherein each of the seating segments is configured to receive one of the lower ends and support wings on one of the spider arms.

11. The spider assembly of claim 10 wherein the seating segments are each configured to extend above a top surface of the upper rim.

12. The spider assembly of claim 11 wherein the top surface of the upper rim is planar at locations other than the pair of seating segments.

13. The spider assembly of claim 11 wherein each of the pair of seating segments extends circumferentially along the top flange over an angular range of 30-100 degrees.

14. The spider assembly of claim 10 wherein each of the seating segments includes an outer ridge and an inner ridge spaced from each other by a receiving channel.

15. The spider assembly of claim 14 wherein the lower end of each spider arm includes a beam that extends from the lower end, wherein the beam is sized to be received within the receiving channel.

16. The spider assembly of claim 15 wherein the seating segment includes a beam extending above a top surface of the upper rim and the lower end of each spider arm includes a receiving cavity sized to receive the beam.

17. The spider assembly of claim 15 wherein the beam extends along the along a length of the pair of supporting wings past the lower end of each of the spider arms.

18. The spider assembly of claim 10 wherein each of the wings includes a connector opening that receives a connector to attach the wing to the upper rim of the top shell.

19. A spider assembly for use with a gyratory crusher including a top shell having an upper rim for supporting the spider assembly, comprising:
a plurality of spider arms each extending radially outward from a center hub, each spider arm including a lower end;
a pair of support wings extending in opposite directions from the lower end of each of the spider arms;
a pair of seating segments located along the upper rim of the top shell, wherein each of the seating segments includes an outer ridge and an inner ridge spaced from each other by a receiving channel; and
a beam extending from the lower end of each spider arm and the pair of support wings extending from the lower end, wherein the beam is sized to be received within the receiving channel.

20. The spider assembly of claim 19 wherein each of the seating segments are attached to the top surface of the upper rim and the upper rim is planar at locations other than the pair of seating segment.
